(19) United States
(12) Patent Application Publication
(10) Pub. No.: US 2024/0209210 A1
(43) Pub. Date: Jun. 27, 2024

(54) SPHERICAL SILICA POWDER AND METHOD FOR PRODUCING SPHERICAL SILICA POWDER

(71) Applicants: AGC Inc., Tokyo (JP); AGC SI-TECH CO., LTD., Kitakyushu-shi (JP)

(72) Inventors: Hiromichi KAMO, Tokyo (JP); Hajime KATAYAMA, Tokyo (JP); Kohta FUKUMOTO, Tokyo (JP)

(73) Assignees: AGC Inc., Tokyo (JP); AGC SI-TECH CO., LTD., Kitakyushu-shi (JP)

(21) Appl. No.: 18/420,860

(22) Filed: Jan. 24, 2024

Related U.S. Application Data
(63) Continuation of application No. PCT/JP2022/028277, filed on Jul. 20, 2022.

(30) Foreign Application Priority Data
Jul. 28, 2021 (JP) 2021-123495
Nov. 30, 2021 (JP) 2021-194372

(51) Int. Cl. C09C 1/30; C08K 7/18

(52) U.S. Cl. CPC C09C 1/3027; C08K 7/18; C01P 2002/82; C01P 2004/03; C01P 2004/32; C01P 2004/61; C01P 2004/62; C01P 2006/12; C01P 2006/14; C01P 2006/40; C01P 2006/80

(57) ABSTRACT

The present invention relates to a spherical silica powder, having a median diameter d50 of 0.5 μm to 20 μm, and a product A×d50, which is a product of a specific surface area A (m²/g) and the median diameter d50 (μm), of 2.7 μm·m²/g to 5.0 μm·m²/g. The spherical silica powder may have a dielectric loss tangent of 0.0020 or less at a frequency of 1 GHz.

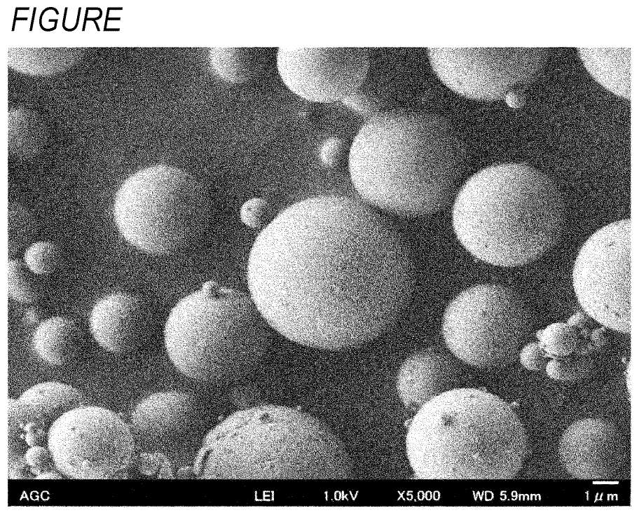

### CROSS-REFERENCE TO RELATED APPLICATIONS

This is a continuation of International Application No. PCT/JP2022/028277 filed on Jul. 20, 2022, and claims priority from Japanese Patent Applications No. 2021-123495 filed on Jul. 28, 2021 and No. 2021-194372 filed on Nov. 30, 2021, the entire contents of which are incorporated herein by reference.

### TECHNICAL FIELD

The present invention relates to a spherical silica powder and a method for producing the spherical silica powder.

### BACKGROUND ART

In recent years, miniaturization of electronic devices, high speed of signals, and densification of wiring are required. In order to satisfy the requirements, it is required that an insulating resin sheet, such as an adhesive film or a prepreg, and a resin composition used in an insulating layer formed on a printed wiring board are made to achieve a low dielectric constant, a low dielectric loss tangent, and a low thermal expansion.

The dielectric characteristics of a ceramic material are known in, for example, Non Patent Literature 1 and the like, but all of them are characteristics of a sintered substrate. Silica (SiO₂) has a small dielectric constant (3.9), a small coefficient of thermal expansion (3 ppm/° C. to 7.9 ppm/° C.), is a promising filler material with a low dielectric constant and low coefficient of thermal expansion, and is already used in many applications. Therefore, it is expected to be widely used in a high frequency band dielectric device or the like.

In order to satisfy these requirements, a low dielectric loss tangent by performing a heat treatment on melt spherical silica powder is studied in Patent Literature 1. In Patent Literature 2, a low dielectric constant and a low dielectric loss tangent are studied by using a crystalline silica as a raw material and molding the raw material into a hollow shape.

### CITATION LIST

### Patent Literature

Patent Literature 1: JP6793282B
Patent Literature 2: JP2021-075438A

### Non-Patent Literature

Non Patent Literature 1: Noboru Ichinose, “Trend of Inorganic Dielectric and Insulating Materials”, Electrical Engineering Journal A, 1993, Vol. 113, No. 7, pp. 495 to 502

### SUMMARY OF INVENTION

### Technical Problem

Spherical silica powder in the related art includes base particles and fine adhesive particles adhered thereto, and the adhesive particles particularly increase a specific surface area. Accordingly, a region where a dielectric loss tangent derived from a surface residue can be reduced is limited.

In the technique described in Patent Literature 1, the spherical silica powder is produced using a spherical silica raw material derived from silica stone, but fine powder is generated in a step of crushing the silica stone, and as a result of this adhering and inclusion, there is a problem in that a specific surface area cannot be reduced and a limit to reduction of the dielectric loss tangent is present. In the technique described in Patent Literature 2, it is necessary to granulate the crystalline silica and melt the product at a high temperature, and there is a problem in productivity.

The present invention has been made in view of the above problems, and an object of the present invention is to provide a novel spherical silica powder having a sufficiently small dielectric loss tangent and excellent miscibility with a resin composition.

### Solution to Problem

As a result of intensive studies, the present inventors have found that the above problems can be solved by producing a spherical silica powder whose specific surface area according to a particle diameter is reduced such that a product of the specific surface area and a median diameter falls within a specific range, leading to completion of the present invention.

The present invention relates to the following (1) to (10).

(1) A spherical silica powder, having a median diameter d50 of 0.5 μm to 20 μm, and a product A×d50, which is a product of a specific surface area A (m²/g) and the median diameter d50 (μm), of 2.7 μm·m²/g to 5.0 μm·m²/g.

(2) The spherical silica powder according to (1) described above, having a dielectric loss tangent of 0.0020 or less at a frequency of 1 GHz.

(3) The spherical silica powder according to (1) or (2) described above, in which a kneaded product containing the spherical silica powder has a viscosity, which is measured by the following measuring method, of 5000 mPa·s or less,

### (Measuring Method)

the kneaded product obtained by mixing 6 parts by mass of boiled linseed oil and 8 parts by mass of the spherical silica powder and by kneading the mixture at 2000 rpm for 3 minutes is measured for 30 seconds at a shear speed of 1 s⁻¹ using a rotary rheometer, and the viscosity of the kneaded product at 30 seconds is obtained.

(4) The spherical silica powder according to any one of (1) to (3) described above, having a maximum IR peak intensity at 3300 cm⁻¹ to 3700 cm⁻¹, which is derived from a bonded silanol group on a surface of the spherical silica powder, of 0.2 or less.

(5) The spherical silica powder according to any one of (1) to (4) described above, including 30 ppm to 1500 ppm of Ti.

(6) A method for producing the spherical silica powder according to any one of (1) to (5) described above, the method including: forming a spherical silica precursor by a wet method.

(7) The method for producing the spherical silica powder according to (6) described above, in which in accordance with JIS K0067:1992, when 1 g of the silica precursor is heated and dried at 850° ° C. for 0.5 hours, a mass loss of the silica precursor is 5.0% by mass to 15.0% by mass.

(8) The method for producing the spherical silica powder according to (6) or (7) described above, in which the silica precursor has a pore volume of 0.3 ml/g to 2.2 ml/g.

(9) A resin composition, including: 5% by mass to 90% by mass of the spherical silica powder according to any one of (1) to (5) described above.

(10) A slurry composition, including: 1% by mass to 50% by mass of the spherical silica powder according to any one of (1) to (5) described above.

### Advantageous Effects of Invention

According to the present invention, the spherical silica powder having a small specific surface area and a sufficiently small dielectric loss tangent can be provided. Since the spherical silica powder of the present invention has a low dielectric loss tangent, an excellent low dielectric loss tangent can be exhibited even in the resin composition. Since the specific surface area with respect to a particle diameter is sufficiently small, dispersibility to a resin is excellent.

### BRIEF DESCRIPTION OF DRAWINGS

The FIGURE shows a scanning electron microscopic image (SEM image) of the spherical silica powder obtained in Example 1.

### DESCRIPTION OF EMBODIMENTS

The present invention will be described below, but the present invention is not limited to examples described below. In addition, in the present specification, an expression “to” used to express a numerical range includes numerical values before and after it as a lower limit value and an upper limit value of the range, respectively.

In the present specification, “mass” is synonymous with “weight”.

The spherical silica powder of the present invention is solid silica, and has a median diameter d50, which is a particle diameter at a point where a cumulative volume is 50% in a volume-based particle size distribution curve, of 0.5 μm to 20 μm and a product A×d50, which is a product of a specific surface area A (m²/g) and the median diameter d50 (μm), of in a range of 2.7 μm·m²/g to 5.0 μm·m²/g (2.7≤A×d50 (μm·m²/g)≤ 5.0).

In the case where the median diameter d50 of the spherical silica powder is 0.5 μm or more, a dielectric loss tangent can be significantly reduced. In addition, in the case where the median diameter becomes too large, a value of a particle gauge becomes large, and thus, when a resin composition containing the spherical silica powder is formed into, for example, a sheet, a minimum thickness of the sheet becomes thick. Accordingly, in the present invention, the median diameter d50 of the spherical silica powder is in the range of 0.5 μm to 20 μm. The median diameter d50 is preferably 0.5 μm to 10 μm, and further preferably 1 μm to 5 μm.

A 10% particle diameter d10, which is a particle diameter at which the cumulative volume becomes 10% in the volume-based particle size distribution curve of the spherical silica powder, is preferably 0.5 μm to 5.0 μm, and more preferably 1.0 μm to 3.0 μm, from a viewpoint of improving uniform dispersibility in the resin composition and enhancing an interaction between the spherical silica powder and the resin.

A ratio (d50/d10) of the median diameter d50 to the 10% particle diameter d10 is preferably more than 1.0 and 5.0 or less, more preferably 1.3 to 4.0, and still more preferably 1.5 to 3.0, from the viewpoint of improving the uniform dispersibility in the resin composition and enhancing the interaction between the spherical silica powder and the resin.

A particle size distribution of silica particles contained in the resin composition is preferably unimodal. The matter that the particle size distribution of the silica particles is unimodal can be confirmed from a matter that there is one peak in the particle size distribution according to a laser diffraction and scattering method.

A maximum particle diameter (Dmax) of the spherical silica powder is preferably 150 times or less, more preferably 100 times or less, further preferably 50 times or less, and particularly preferably 10 times or less of the median diameter d50. In the case where the maximum particle diameter (Dmax) is 150 times or less of the median diameter d50, it is difficult to cause defects when the sheet is processed. The maximum particle diameter (Dmax) is preferably 1.2 times or more, more preferably 1.5 times or more, and still more preferably 2 times or more of the median diameter d50.

The median diameter d50 is a volume-based cumulative 50% diameter obtained by a laser diffraction particle size distribution analyzer (for example, “MT3300EXII” manufactured by MicrotracBEL Corp.). That is, the particle size distribution is measured by the laser diffraction and scattering method, a cumulative curve is obtained by setting a total volume of the spherical silica powder to 100%, and the volume-based cumulative 50% diameter represents a particle diameter at a point on the cumulative curve where the cumulative volume is 50%.

The 10% particle diameter d10 is a volume-based cumulative 10% diameter obtained by the laser diffraction particle size distribution analyzer (for example, “MT3300EXII” manufactured by MicrotracBEL Corp.). That is, the particle size distribution is measured by the laser diffraction and scattering method, a cumulative curve is obtained by setting a total volume of the spherical silica powder to 100%, and the volume-based cumulative 10% diameter represents a particle diameter at a point on the cumulative curve where the cumulative volume is 10%.

The maximum particle diameter is also obtained by the same measurement as the median diameter d50 and the 10% particle diameter d10.

The specific surface area A of the spherical silica powder of the present invention is preferably in the range of 0.2 m²/g to 2.0 m²/g. In the case where the specific surface area is 0.2 m²/g or more, a contact point with the resin is sufficient when the spherical silica powder is contained in the resin composition, and thus, the powder becomes more compatible with the resin, and in the case where the specific surface area is 2.0 m²/g or less, the dielectric loss tangent can be reduced, and thus, an excellent low dielectric loss tangent even in the resin composition can be exhibited, and dispersibility in the resin composition can be improved. The specific surface area A is preferably 0.2 m²/g to 2.0 m²/g, more preferably 0.5 m²/g to 2.0 m²/g, still more preferably 0.5 m²/g to 1.5 m²/g, and particularly preferably 0.8 m²/g to 1.5 m²/g. Here, the specific surface area A is preferably 2.0 m²/g or less, more preferably 1.5 m²/g or less, and is preferably 0.2 m²/g or more, more preferably 0.5 m²/g or more, and particularly preferably 0.8 m²/g or more. It is substantially difficult to obtain a material with the specific surface area A of less than 0.2 m²/g.

The specific surface area is obtained by a BET method based on a nitrogen adsorption method using the specific surface area and pore distribution measuring device (for example, “BEI SORP-minill” manufactured by MicrotracBEI, Corp., “TriStar II” manufactured by Micromeritics Instrument Corporation).

The product A×d50 of the specific surface area A (m²/g) of the spherical silica powder and the median diameter d50 (μm) is 2.7 μm·m²/g to 5.0 μm·m²/g, preferably 2.7 μm·m²/g to 4.5 μm·m²/g, and more preferably 2.7 μm·m²/g to 4.0 μm·m²/g. A theoretical value of A×d50 is 2.7 [derived from specific surface area=6/(true density of silica of 2.2 (g/cm³)×median diameter d50 (μm))], and values below this theoretical value are practically unachievable. The larger the value of A×d50, the larger the specific surface area per particle diameter and the larger the dielectric loss tangent, and thus, in order to reduce the dielectric loss tangent to about 0.0020 or less at a frequency of 1 GHZ, A×d50 is set to 5.0 μm·m²/g or less.

A sphericity of the spherical silica powder is preferably 0.75 to 1.0. In the case where the sphericity is low, the specific surface area increases, and thus, the dielectric loss tangent easily increases, and therefore, the sphericity is preferably 0.75 or more. The sphericity is preferably 0.75 or more, more preferably 0.90 or more, still more preferably 0.93 or more, and is preferably close to 1.0.

The sphericity can be represented by an average value obtained by measuring a longest diameter (DL) and a shortest diameter (DS) orthogonal to the longest diameter (DL) of arbitrary 100 particles in a photograph projection view that is obtained by capturing with a scanning electron microscope (SEM), and calculating a ratio (DS/DL) of the shortest diameter (DS) to the longest diameter (DL).

The dielectric loss tangent of the spherical silica powder of the present invention is preferably 0.0020 or less, more preferably 0.0010 or less, and still more preferably 0.0008 or less at the frequency of 1 GHz. In particular, in the measurement of the dielectric loss tangent and the dielectric constant of the powder, if the frequency is 10 GHz or more, a sample space becomes small and a measurement accuracy deteriorates, and thus, values measured at the frequency of 1 GHz are used in the present invention. In the case where the dielectric loss tangent at the frequency of 1 GHz of the spherical silica powder is 0.0020 or less, an excellent reduction effect of dielectric loss can be obtained, and thus, a substrate or sheet having improved high-frequency characteristics can be obtained. As the dielectric loss tangent is smaller, a transmission loss of a circuit is reduced, and thus, a lower limit value thereof is not particularly limited.

From the same viewpoint, the dielectric constant of the spherical silica powder is preferably 5.0 or less, more preferably 4.5 or less, and still more preferably 4.1 or less at the frequency of 1 GHz.

The dielectric loss tangent and the dielectric constant can be measured by a perturbation resonator method using a dedicated device (for example, “vector network analyzer E5063A” manufactured by a KEYCOM Corp.).

The spherical silica powder of the present invention preferably has a viscosity, which is measured by the following measuring method, of 5000 mPa·s or less in a kneaded product containing the spherical silica powder.

### (Measuring Method)

The kneaded product obtained by mixing 8 parts by mass of the spherical silica powder and 6 parts by mass of boiled linseed oil specified in JIS K 5421:2000 and by kneading the mixture at 2000 rpm for 3 minutes is measured for 30 seconds at a shear speed of 1 s⁻¹ using a rotary rheometer, and the viscosity of the kneaded product at 30 seconds is obtained.

In the case where the viscosity at the shear speed of 1 s⁻¹ of the kneaded product obtained by the above measuring method is 5000 mPa·s or less, an amount of a solvent added at the time of molding the resin composition containing the spherical silica powder and forming a film can be reduced, a drying rate can be increased, and productivity can be improved. In addition, in the case where the specific surface area of the silica powder according to the particle diameter increases, the viscosity tends to increase when the silica powder is added to the resin composition, but the spherical silica powder of the present invention can prevent an increase in the viscosity of the resin composition since the specific surface area thereof is small. The viscosity of the kneaded product is more preferably 4000 mPa·s or less, and still more preferably 3500 mPa·s or less.

A lower limit value of the viscosity of the kneaded product at the shear speed of 1 s⁻¹ is not particularly limited because the lower the viscosity, the better coating properties of the resin composition and the higher the productivity.

An IR peak intensity in the vicinity of 3746 cm⁻¹, which is derived from an isolated silanol group on the surface of the spherical silica powder of the present invention, is preferably 0.1 or less, more preferably 0.08 or less, and still more preferably 0.06 or less. The isolated silanol group is a silanol (Si—OH) group that is not bonded to water or the like adsorbed to the silica particles. An amount of the isolated silanol (Si—OH) group on the surface of the silica particles is obtained by IR measurement. Specifically, an IR spectrum is normalized at 800 cm⁻¹, a base line is aligned at 3800 cm⁻¹, and then a relative value of the Si—OH peak intensity in the vicinity of 3746 cm⁻¹ is obtained. In the case where the number of isolated silanol groups on the particle surface is large, the dielectric loss tends to increase when the member mixed with the resin is used for electronic applications, and in the case where the IR peak intensity in the vicinity of 3746 cm⁻¹, which is derived from the isolated silanol group on the particle surface, is 0.1 or less, the dielectric loss can be reduced.

A maximum IR peak intensity at 3300 cm⁻¹ to 3700 cm⁻¹, which is derived from the bonded silanol group on the surface of the spherical silica powder of the present invention, is preferably 0.2 or less, more preferably 0.17 or less, and still more preferably 0.15 or less. The bonded silanol group is a silanol (Si—OH) group bonded to water adsorbed to the silica particles, or bonded to silanol on the silica surface. An amount of the bonded silanol (Si—OH) group on the surface of the silica particles is obtained by IR measurement. Specifically, the IR spectrum is normalized at 800 cm⁻¹, the base line is aligned at 3800 cm⁻¹, and then the relative value of the bonded Si—OH peak intensity is obtained from the maximum peak at 3300 cm⁻¹ to 3700 cm⁻¹. In the case where the number of bonded silanol groups on the particle surface is large, the dielectric loss tends to increase when the member mixed with the resin is used for electronic applications, and in the case where a maximum IR peak intensity at 3300 cm⁻¹ to 3700 cm⁻¹, which is derived from the bonded silanol group on the particle surface, is 0.2 or less, the dielectric loss can be reduced.

The spherical silica powder of the present invention is preferably a non-porous particle. In the case where the spherical silica powder is a porous particle, an oil absorption value increases, the viscosity in the resin increases, the surface area increases, the amount of silanol (Si—OH) groups on the surface of the silica particles increases, and the dielectric loss tangent tends to deteriorate. Specifically, the oil absorption value is preferably 100 ml/100 g or less, more preferably 70 ml/100 g or less, and most preferably 50 ml/100 g or less. A lower limit value is not particularly limited, but it is substantially difficult to set the oil absorption value to 20 ml/100 g or less.

Regarding measurement of the oil absorption value, it is preferable to use boiled linseed oil in accordance with JIS K5101-13-2:2004.

The spherical silica powder of the present invention preferably includes titanium (Ti) in a range of 30 ppm to 1500 ppm, more preferably 100 ppm to 1000 ppm, and still more preferably 100 ppm to 500 ppm. A concentration of titanium can be measured by inductively coupled plasma (ICP) emission spectrometry after adding perchloric acid and hydrofluoric acid to the silica powder, igniting the mixture, and removing silicon which is the main component.

Ti is a component that is optionally included in the production of the spherical silica powder. In the production of the spherical silica powder, if fine powder is generated due to crack of the silica particles, the fine powder adheres to a surface of a base particle, and the specific surface area of the particle is increased. By including Ti at the time of producing the spherical silica powder, it is easy to thermally compact during firing. Accordingly, it is difficult to crack during post-processing after firing, and thus, generation of the fine powder can be prevented, and the number of adhesive particles adhering to the surface of the silica base particles can be reduced, thereby preventing an increase in the specific surface area. By including 30 ppm or more of Ti, it is easy to thermally compact during firing, and thus, the generation of the fine powder due to cracking can be reduced, and in the case where a content of Ti is less than or equal to 1500 ppm, the above-described effect can be obtained, an increase in the amount of the silanol group can be prevented and deterioration of the dielectric loss tangent can be prevented.

The spherical silica powder of the present invention may include an impurity element other than titanium (Ti) as long as the effect of the present invention is not impaired. Examples of the impurity element include Na, K, Mg, Ca, Al, and Fe in addition to Ti.

A content of an alkali metal and an alkaline earth metal in the impurity element is preferably 2000 ppm or less, more preferably 1000 ppm or less, and still more preferably 200 ppm or less in total.

The spherical silica powder of the present invention may be treated with a silane coupling agent.

When the surface of the spherical silica powder is treated with the silane coupling agent, an amount of silanol groups remaining on the surface is reduced, the surface is hydrophobized, and the dielectric loss can be improved by preventing water adsorption, and when preparing the resin composition, affinity with the resin is improved, and dispersibility and strength after resin film formation are improved.

Examples of the silane coupling agent include aminosilane coupling agents, epoxysilane coupling agents, mercaptosilane coupling agents, silane coupling agents, and organosilazane compounds. One type of the silane coupling agent may be used or two or more types thereof may be used in combination.

An adhesion amount of the silane coupling agent is preferably 0.01 parts by mass to 5 parts by mass, more preferably 0.02 parts by mass to 5 parts by mass, and still more preferably 0.1 parts by mass to 2 parts by mass with respect to 100 parts by mass of the spherical silica powder. Here, the adhesion amount of the silane coupling agent is preferably 0.01 parts by mass or more, more preferably 0.02 parts by mass or more, and still more preferably 0.1 parts by mass or more, and is preferably 5 parts by mass or less, and more preferably 2 parts by mass or less with respect to 100 parts by mass of the spherical silica powder.

A matter that the surface of the spherical silica powder is treated with the silane coupling agent can be confirmed by detection of the peak due to a substituent group of the silane coupling agent according to IR. The adhesion amount of the silane coupling agent can be measured by an amount of carbon.

### (Method for Producing Spherical Silica Powder)

A method for producing the spherical silica powder of the present invention includes forming a spherical silica precursor by a wet method. The wet method refers to a method including a step of obtaining a raw material of the spherical silica powder by using a liquid as a silica source and gelling the liquid. By using the wet method, spherical silica particles can be formed, and thus, there is no need to adjust a shape of the particles by crushing or the like, and as a result, particles with a small specific surface area can be obtained. In the wet method, the particles that are significantly smaller than an average particle diameter are hardly generated, and the specific surface area tends to be smaller after firing. In the wet method, the amount of the impurity element such as titanium can be adjusted by adjusting impurities of the silica source, and the above-described impurity element can be uniformly dispersed in the particles.

Examples of the wet method include a spraying method and an emulsion gelling method. In the emulsion gelling method, for example, a dispersion phase containing a silica precursor and a continuous phase are emulsified, and the obtained emulsion is gelled to thereby obtain a spherical silica precursor. In an emulsification method, it is preferable to prepare an emulsion by supplying the dispersion phase containing the silica precursor to the continuous phase through a fine pore portion or a porous film. Accordingly, an emulsion having a uniform liquid droplet diameter is prepared, and as a result, spherical silica having a uniform particle diameter is obtained. Such an emulsification method may be a micromixer method or a film emulsification method. For example, the micromixer method is disclosed in WO2013/062105.

A pore volume of the spherical silica precursor obtained by the wet method is preferably 0.05 ml/g to 2.2 ml/g. In the case where the pore volume of the silica precursor is 0.05 ml/g or more, the silica particle sufficiently shrink during firing, and the specific surface area can be reduced. In the case where the pore volume of the silica precursor is 2.2 ml/g or less, it is possible to prevent an excessive increase in loose bulk density before firing, and to improve productivity. The pore volume of the silica precursor is preferably 0.05 ml/g to 2.2 ml/g, more preferably 0.1 ml/g to 2.2 ml/g, more preferably 0.3 ml/g to 2.2 ml/g, still more preferably 0.3 ml/g to 1.8 ml/g, particularly preferably 0.6 ml/g to 1.8 ml/g, and most preferably 0.7 ml/g to 1.5 ml/g. Here, the pore volume of the silica precursor is preferably 0.05 ml/g or more, more preferably 0.1 ml/g or more, still more preferably 0.3 ml/g or more, particularly preferably 0.6 ml/g or more, and most preferably 0.7 ml/g or more, and is preferably 2.2 ml/g or less, more preferably 1.8 ml/g or less, and most preferably 1.5 ml/g or less.

The pore volume is obtained by a BJH method based on the nitrogen adsorption method using the specific surface area and pore distribution measuring device (for example, “BELSORP-minill” manufactured by MicrotracBEL Corp., “TriStar II” manufactured by Micromeritics Instrument Corporation).

An ignition loss of the silica precursor obtained by the wet method is preferably 5.0% by mass to 15.0% by mass, more preferably 6.0% by mass to 13.0% by mass, and still more preferably 7.0% by mass to 12.0% by mass. The ignition loss is a sum of a mass of adhering water adhered to the silica precursor and a mass of water generated from condensation of the silanol group contained in the silica precursor, and the silica precursor has an appropriate silanol group, so that the condensation progresses during firing, and the silanol group easily decreases. In the case where the ignition loss is too large, a yield during firing is lowered and productivity deteriorates, and thus, the ignition loss of the silica precursor is preferably 15.0% by mass or less, more preferably 13.0% by mass or less, and most preferably 12.0% by mass or less. In the case where the ignition loss is too small, the silanol group is likely to remain during firing, and thus, the ignition loss of the silica precursor is preferably 5.0% by mass or more, more preferably 6.0% by mass or more, and most preferably 7.0% by mass or more.

Here, the ignition loss is obtained as the mass loss when 1 g of the silica precursor is heated and dried at 850° ° C. for 0.5 hours in accordance with JIS K0067:1992.

An average pore diameter of the silica precursor is preferably 1.0 nm to 50.0 nm. In the case where the average pore diameter is 1.0 nm or more, the inside of the particles can be made uniformly non-porous, no air bubbles remain inside, and the dielectric loss tangent is reduced. In the case where the average pore diameter is 50.0 nm or less, the silica particles can be densified (lower specific surface area) by firing without leaving any pores, and thus, the dielectric loss tangent can be lowered. The average pore diameter is preferably 1.0 nm to 50.0 nm, more preferably 2.0 nm to 40.0 nm, still more preferably 3.0 nm to 30.0 nm, and particularly preferably 4.0 nm to 20.0 nm. Here, the average pore diameter is preferably 1.0 nm or more, more preferably 2.0 nm or more, still more preferably 3.0 nm or more, and particularly preferably 4.0 nm or more, and is preferably 50.0 nm or less, more preferably 40.0 nm or less, still more preferably 30.0 nm or less, and particularly preferably 20.0 nm or less.

The average pore diameter is obtained by the BET method based on the nitrogen adsorption method using the specific surface area and pore distribution measuring device (for example, “BELSORP-miniII” manufactured by MicrotracBEL Corp., “TriStar II” manufactured by Micromeritics Instrument Corporation).

The silica precursor preferably has a weight reduction rate of 10% or less when dried at 230° C. for 12 hours. In the case where the weight reduction rate is 10% or less, when the silica precursor is fired in a state where the particles are in contact with each other, sintering of the particles hardly occurs, and the spherical silica powder is easily obtained.

The weight reduction rate is more preferably 9% or less, still more preferably 8% or less, and particularly preferably 6% or less, and since it is desirable that the weight does not change even after drying at 230° ° C. for 12 hours, a lower limit is not particularly limited.

When the water content of the obtained silica precursor is large and the weight reduction rate when the silica precursor is dried at 230° C. for 12 hours is more than 10%, the silica precursor is preferably dried such that the weight reduction rate is 10% or less. Examples of drying means include a spray dryer, static drying in a dryer, and ventilation treatment with dry air.

The spherical silica powder is obtained by performing the heat treatment on the spherical silica precursor. In the heat treatment, when the spherical silica powder is burned and densified, the amount of the silanol group on the surface is reduced to cause the dielectric loss tangent to decrease. A temperature of the heat treatment is preferably 700° ° C. to 1600° C., more preferably 800° ° C. to 1500° C., and still more preferably 900° ° C. to 1400° C. Here, the temperature of the heat treatment is preferably 700° ° C. or more, more preferably 800° C. or more, and most preferably 900° ° C. or more, and in the case where the temperature becomes too high, the particles tend to aggregate and particle gauge in the resin composition becomes large, and thus, the temperature is preferably 1600° C. or lower, more preferably 1500° C. or lower, and most preferably 1400° C. or lower.

The heat treatment time may be appropriately adjusted in accordance with a device to be used, and heat treatment is preferably performed, for example, for 0.5 hours to 50 hours, and more preferably 1 hour to 10 hours.

An atmosphere during the heat treatment may be an atmosphere containing oxygen or an atmosphere containing no oxygen. In a case of forming a sphere by a wet method, an organic substance such as an emulsion is often used, and thus, an organic substance often remains in the silica precursor. When a silica precursor containing a small amount of organic substances is fired, the organic substances are carbonized under a condition with a small amount of oxygen, causing an increase in the dielectric loss tangent and coloring. Accordingly, when the silica precursor contains an organic substance, firing is preferably performed in an atmosphere containing oxygen, and more preferably in an air atmosphere.

A method for the heat treatment is not particularly limited, and examples thereof include a heat treatment by a stationary method, a heat treatment by a rotary kiln method, and a heat treatment by spray combustion.

In the method for the heat treatment, a spherical porous silica precursor is preferably fired in a state where particles are in contact with each other. When the silica precursor is fired in the state where the particles are in contact with each other, firing can be performed with a small volume, and thus, compared to, for example, a case where the silica precursor is dispersed in a gas and then fired, the temperature irregularity and time irregularity during firing are smaller, and therefore, spherical silica powder with constant quality can be obtained. By firing the silica precursor in the state where the particles are in contact with each other, the firing conditions for each silica precursor can be made uniform and a constant quality can be maintained.

The particles of the spherical silica powder may be weakly sintered together after firing, and thus, in that case, the spherical silica powder may be crushed. In order to maintain sphericity and surface area, crushing is preferably carried out such that an average circularity of the particles does not fall below 0.90 so as not to impair effects of the present invention. It is preferable that the surface area is not increased by the crushing treatment. A large increase in the surface area in the crushing treatment means that some of the spherical particles are crushed and fine damage occurs on the surface to generate fine powder. The increase in the surface area is not preferable because this increase leads to an increase in the viscosity when the powder is dispersed in a resin and leads to deterioration of the dielectric loss tangent.

The crushing can be performed using a crushing device such as a cyclone mill or a jet mill, or can also be performed using a vibrating sieve.

The fired spherical silica powder may be surface-treated with a silane coupling agent. According to this step, the silanol group, which is present on the surface of the spherical silica powder, and the silane coupling agent react with each other, the silanol group on the surface is decreased, and the dielectric loss tangent is enhanced. Since the surface is hydrophobized and the affinity for the resin is improved, the dispersibility in the resin is improved.

The conditions for the surface treatment are not particularly limited, and general surface treatment conditions may be used, and a wet treatment method or a dry treatment method may be used. From a viewpoint of performing a uniform treatment, a wet treatment method is preferable.

Examples of the silane coupling agent used in the surface treatment include aminosilane coupling agents, epoxysilane coupling agents, mercaptosilane coupling agents, silane coupling agents, and organosilazane compounds. The above may be used alone or in combination.

Specifically, examples of a surface treatment agent include an aminosilane coupling agent such as aminopropylmethoxysilane, aminopropyltriethoxysilane, ureidopropyltriethoxysilane, N-phenylaminopropyltrimethoxysilane, and N-2(aminoethyl)aminopropyltrimethoxysilane, an epoxysilane coupling agent such as glycidoxypropyltrimethoxysilane, glycidoxypropyltriethoxysilane, glycidoxypropylmethyldiethoxysilane, glycidylbutyltrimethoxysilane, and (3,4-epoxycyclohexyl)ethyltrimethoxysilane, a mercaptosilane coupling agent such as mercaptopropyltrimethoxysilane and mercaptopropyltriethoxysilane, a silane coupling agent such as methyltrimethoxysilane, vinyltrimethoxysilane, octadecyltrimethoxysilane, phenyltrimethoxysilane, methacryloxypropyltrimethoxysilane, imidazolesilane, triazinesilane, a fluorine-containing silane coupling agent such as CF₃(CF₂)₇CH₂CH₂Si(OCH₃)₃, CF₃(CF₂)₇CH₂CH₂SiCl₃, CF₃(CF₂)₇CH₂CH₂Si(CH₃)(OCH₃)₂, CF₃(CF₂)₇CH₂CH₂Si(CH₃)Cl₂, CF₃(CF₂)₅CH₂CH₂SiCl₃, CF₃(CF₂)₅CH₂CH₂Si(OCH₃)₃, CF₃CH₂CH₂SiCl₃, CF₃CH₂CH₂Si(OCH₃)₃, C₈F₁₇SO₂N(C₃H₇)CH₂CH₂CH₂Si(OCH₃)₃, C₇F₁₅CONHCH₂CH₂CH₂Si(OCH₃)₃, C₈F₁₇CO₂CH₂CH₂CH₂Si(OCH₃)₃, C₈F₁₇—O—CF(CF₃)CF₂—O—C₃H₆SiCl₃, C₃F₇—O—(CF(CF₃)CF₂—O)₂—CF(CF₃)CONH—(CH₂)₃Si(OCH₃)₃, and an organosilazane compounds such as hexamethyldisilazane, hexaphenyldisilazane, trisilazane, cyclotrisilazane, and 1,1,3,3,5,5-hexamethylcyclotrisilazane.

A treatment amount of the silane coupling agent is preferably 0.01 parts by mass or more, more preferably 0.02 parts by mass or more, and still more preferably 0.10 parts by mass or more, and is preferably 5 parts by mass or less, and more preferably 2 parts by mass or less with respect to 100 parts by mass of the spherical silica powder.

Examples of the method for treating with the silane coupling agent include a dry method in which the silane coupling agent is sprayed to the spherical silica powder, and a wet method in which the spherical silica powder is dispersed in a solvent and then a silane coupling agent is added to react with the mixture.

### (Resin Composition and Slurry Composition)

The spherical silica powder of the present invention has a small specific surface area, and thus, dispersibility in various solvents is good, and miscibility with a resin composition is excellent.

The resin composition according to the present embodiment includes the spherical silica powder of the present invention and the resin. A content of the spherical silica powder in the resin composition is preferably 5% by mass to 90% by mass, more preferably 10% by mass to 85% by mass, still more preferably 10% by mass to 80% by mass, particularly preferably 10% by mass to 75% by mass, further particularly preferably 10% by mass to 70% by mass, and most preferably 15% by mass to 70% by mass. In the case where the content of the spherical silica powder is 5% by mass or more, sufficient peeling strength can be obtained, and in the case where the content is 90% by mass or less, the viscosity of the resin composition does not increase too much and can be treated easily. Here, the content of the spherical silica powder in the resin composition is preferably 5% by mass or more, more preferably 10% by mass or more, still more preferably 15% by mass or more, and is preferably 90% by mass or less, more preferably 85% by mass or less, still more preferably 80% by mass or less, particularly preferably 75% by mass or less, and most preferably 70% by mass or less.

The resin may use one or two or more types of a polyamide resin such as an epoxy resin, a silicone resin, a phenol resin, a melamine resin, a urea resin, an unsaturated polyester resin, a fluororesin, a polyimide resin, a polyamide-imide resin, or a polyether imide; a polyester resin such as a polybutylene terephthalate or a polyethylene terephthalate; a polyphenylene ether resin, a polyphenylene sulfide resin, a phenol resin, an ortho-divinyl benzene resin, an aromatic polyester resin, a polysulfone, a liquid crystal polymer, a polyethersulfone, a polycarbonate, a maleic imide modified resin, an acrylonitrile butadiene styrene (ABS) resin, an acrylonitrile-acrylic rubber-styrene (AAS) resin, an acrylonitrile-ethylene-propylene-diene rubber-styrene (AES) resin, a poly tetrafluoroethylene (PTFE), a tetrafluoroethylene-perfluoroalkyl vinyl ether copolymer (PFA), a tetrafluoroethylene-hexafluoropropylene copolymer (FEP), and a tetrafluoroethylene-ethylene copolymer (ETFE). Since the dielectric loss tangent in the resin composition also depends on characteristics of the resin, the resin to be used may be selected in consideration of this factor.

The resin preferably includes a thermosetting resin. The thermosetting resins may be used alone or in combination. Examples of the thermosetting resin include an epoxy resin, a polyphenylene ether resin, a polyimide resin, a phenol resin, and an ortho-divinyl benzene resin. From viewpoints of adhesiveness, heat resistance, and the like, the thermosetting resin is preferably an epoxy resin, a polyphenylene ether resin, or an ortho-divinyl benzene resin.

From viewpoints of adhesiveness, dielectric characteristics, and the like, a weight average molecular weight of the thermosetting resin is preferably 1000 to 7000, more preferably 1000 to 5000, and still more preferably 1000 to 3000. The weight average molecular weight is determined by gel permeation chromatography (GPC) in terms of polystyrene.

From viewpoints of prevention on uneven distribution of the silica particles, reduction in water absorption, low dielectric loss tangent, adhesiveness, and the like, the content of the spherical silica powder with respect to 100 parts by mass of the thermosetting resin is preferably 10 parts by mass to 400 parts by mass, more preferably 50 parts by mass to 300 parts by mass, and still more preferably 70 parts by mass to 250 parts by mass. In particular, when the silica particles are preferably highly filled, the content of the silica particles is preferably 80 parts by mass or more, and more preferably 90 parts by mass or more.

Due to the working mechanism described above, the spherical silica powder is sufficiently wetted and uniformly dispersed, and is highly likely to interact with the thermosetting resin. Therefore, even in the present composition in which the content is in such a range, that is, in the present composition in which the spherical silica powder is added with large amount with respect to the thermosetting resin, both components are easily stabilized, and a molded product having excellent adhesiveness to a metal base layer can be formed.

The spherical silica powder of the present invention can be used as a filler of a slurry composition. The slurry composition refers to a muddy composition in which the spherical silica powder of the present invention is dispersed in an aqueous or oil medium.

The content of the spherical silica powder in the slurry composition is preferably 1% by mass to 50% by mass, and more preferably 5% by mass to 40% by mass.

Examples of the oil medium include acetone, methanol, ethanol, butanol, 2-propanol, 1-propanol, isobutyl alcohol, 1-butanol, 2-butanol, 2-methoxyethanol, 2-ethoxyethanol, 1-methoxy-2-propanol, 2-acetoxy-1-methoxypropane, propyl acetate, isobutyl acetate, butyl acetate, toluene, xylene, methyl ethyl ketone, methyl isobutyl ketone, N,N-dimethylformamide, methyl isobutyl ketone, N-methylpyrrolidone, n-hexane, n-heptane, cyclohexane, methylcyclohexane, cyclohexanone, and naphtha as a mixture. The above may be used alone or as a mixture of two or more.

The resin composition and the slurry composition may include an optional component other than the resin and the medium. Examples of the optional component include a dispersion aid, a surfactant, and a filler other than silica.

Regarding a dispersion treatment of a mixed liquid containing the solvent and the spherical silica powder, a dispersion device used for pigment dispersion or the like can be used. Examples thereof include a mixer such as a disper, a homomixer, or a planetary mixer, a homogenizer (for example, “CLEARMIX” manufactured by M Technique Co., Ltd., “FILMIX” manufactured by PRIMIX Corporation, or “Abramix” manufactured by Silverson Co., Ltd.), a paint conditioner (manufactured by Red Devil, Inc.), a colloid mill (for example, “PUC colloid mill” manufactured by PUC Inc. and “colloid mill MK” manufactured by IKA), a cone mill (for example, “cone mill MKO” manufactured by IKA), a media type disperser such as a ball mill, a sand mill (for example, “DYNO-MILL” manufactured by SHINMARU ENTERPRISES CORPORATION), an attritor, a pearl mill (for example, “DCP mill” manufactured by Eirich), and a coball mill; a medialess disperser such as a wet jet mill (for example, “Genus PY” manufactured by Genus Corporation, “STAR BURST” manufactured by Sugino Machine Limited., “Nanomizer” manufactured by NANOMIZER Inc.), “CIEAR SS-5” manufactured by M Technique Co., Ltd., and “MICROS” manufactured by Nara Machinery Co., Ltd.; and other roll mills and kneaders. In the above, a crushing media (ball, bead, or the like) is preferably not used. This is because when a crushing media is used, contamination of the worn media is concerned. Specifically, a wet jet mill (for example, “Genus PY” manufactured by Genus Corporation, “STAR BURST” manufactured by Sugino Machine Limited., “Nanomizer” manufactured by NANOMIZER Inc.), and the medialess disperser such as “CIEAR SS-5” manufactured by M Technique Co., Ltd., or “MICROS” manufactured by NARA MACHINERY CO., LTD. are desirable.

A temperature during the dispersion treatment is preferably 0° ° C. to 100° C. By performing the dispersion treatment in the temperature range, the viscosity of the solvent is appropriately maintained, the productivity is maintained, and evaporation of the solvent is prevented and a solid content can be easily controlled. The treatment temperature is preferably 0° ° C. to 100° C., more preferably 5° ° C. to 90° C., and still more preferably 10° ° C. to 80° ° C. Here, the treatment temperature is more preferably 5° C. or more, and still more preferably 10° C. or more, and is more preferably 90° C. or less, and still more preferably 80° C. or less.

A time of the dispersion treatment may be appropriately set depending on the dispersion device to be used such that the particle breakage does not proceed, and is preferably 0.5 minutes to 60 minutes, more preferably 0.5 minutes to 10 minutes, and still more preferably 0.5 minutes to 5 minutes.

Thereafter, aggregates of the spherical silica powder remained without being dispersed even in the dispersion treatment are subjected to wet classification. The wet classification includes classification using a sieve or a centrifugal force. In the case of using the sieve, classification is preferably performed by a sieve having an opening of 100 μm or less. As the sieve, for example, a metal having a dense lattice structure such as an electroformed sieve is preferably used.

The opening of the sieve is preferably 0.2 μm to 100 μm, more preferably 0.5 μm to 75 μm, still more preferably 0.5 μm to 50 μm, and particularly preferably 1 μm to 35 μm. Here, the opening of the sieve is preferably 100 μm or less, more preferably 75 μm or less, still more preferably 50 μm or less, particularly preferably 35 μm or less, and is preferably 0.2 μm or more, more preferably 0.5 μm or more, and still more preferably 1 μm or more.

Thereafter, dilution or concentration may be performed as necessary to adjust a concentration to an appropriate value. Examples of the concentration method include vaporization and concentration, and solid-liquid separation.

In the method for producing the slurry composition of the present invention, a silane coupling agent may be added to a mixed liquid of the solvent and the spherical silica powder. Examples of the silane coupling agent include the silane coupling agent described above.

When a resin film is produced using the resin composition including the spherical silica powder of the present invention, the dielectric loss tangent is preferably 0.012 or less, more preferably 0.010 or less, and still more preferably 0.009 or less at a frequency of 10 GHz. In the case where the dielectric loss tangent at the frequency of 10 GHz of the resin film is 0.012 or less, the resin film can be expected to be used for electronic devices, communication devices, and the like because of excellent electrical characteristics. As the dielectric loss tangent is smaller, a transmission loss of a circuit is reduced, and thus, a lower limit value thereof is not particularly limited.

When the resin film is produced using the resin composition including the spherical silica powder of the present invention, a specific dielectric constant thereof is preferably 2.0 to 3.5 at the frequency of 10 GHz, a lower limit is more preferably 2.2 or more, still more preferably 2.3 or more, and an upper limit is more preferably 3.2 or less, and still more preferably 3.0 or less. In the case where the specific dielectric constant of the resin film at the frequency of 10 GHz is within the above range, the resin film can be expected to be used for electronic devices, communication devices, and the like because of excellent electrical characteristics.

The specific dielectric constant can be measured by a perturbation resonator method using a dedicated device (for example, “vector network analyzer E5063 A” manufactured by a KEYCOM Corp.).

The dielectric loss tangent of the resin film can be measured using a split post dielectric resonator (SPDR) (for example, manufactured by Agilent Technologies Japan, Ltd.).

The above resin film preferably has an average coefficient of linear expansion of 10 ppm/° ° C. to 50 ppm/° C. In the case where the average coefficient of linear expansion is in the above range, this range is close to a coefficient of thermal expansion of a copper foil widely used as a base material, and thus, the electrical characteristics are excellent. The average coefficient of linear expansion is more preferably 12 ppm/° C. or more, still more preferably 15 ppm/° ° C. or more, and more preferably 40 ppm/° C. or less, and still more preferably 30 ppm/° ° C. or less.

A thermomechanical analyzer (for example, “TMA-60” manufactured by Shimadzu Corporation) is used to heat the above resin film at a load of 5N and a temperature increase rate of 2° C./min, measure a dimensional change of a sample from 30° ° C. to 150° C., and calculate an average, thereby obtaining the average coefficient of linear expansion.

The spherical silica powder of the present invention can be used as various fillers, and can be particularly and suitably used as a filler in resin compositions used for production of an electronic substrate used in an electronic device such as a personal computer, a laptop, and a digital camera, and a communication device such as a smartphone and a game console. Specifically, the silica powder of the present invention is expected to be applied to a resin composition, a prepreg, a metal foil-clad laminate, a printed wiring board, a resin sheet, an adhesive layer, an adhesive film, a solder resist, a bump reflow, a rewiring insulating layer, a die bond material, a sealing material, an underfill, a mold underfill, a laminated inductor, and the like in order to achieve the low dielectric loss tangent, the low transmission loss, the low moisture absorption, and the improved peeling strength.

### EXAMPLES

Hereinafter, the present invention will be described with reference to examples, but the present invention is not limited thereto. In the following description, the same common components are used. Unless otherwise specified, “parts” and “%” represent “parts by mass” and “% by mass”, respectively. Examples 1 to 12 are working examples, and Examples 13 to 14 are comparative examples.

### Test Example 1

### Example 1

Silica powder 1 (H-31, d50=3.5 μm, produced by AGC Si-Tech Co., Ltd.) produced by a wet method was used as the spherical silica precursor. A content of titanium (Ti) in the silica powder 1 was measured to be 300 ppm. An alumina crucible was filled with 15 g of the silica powder 1, followed by heat-treating in an electric furnace with a temperature of 1300° C. for 1 hour. After the heat treatment, the mixture was cooled to the room temperature, and was pulverized in an agate mortar to thereby obtain the spherical silica powder.

### Example 2

Except that silica powder 2 (H-51, d50=5.5 μm, produced by AGC Si-Tech Co., Ltd.) produced by a wet method was used as the spherical silica precursor, the spherical silica powder was obtained in the same manner as in Example 1.

A content of Ti in the silica powder 2 used as the spherical silica precursor was measured to be 300 ppm.

### Example 3

Except that silica powder 3 (H-121, d50=13 μm, produced by AGC Si-Tech Co., Ltd.) produced by a wet method was used as the spherical silica precursor, the spherical silica powder was obtained in the same manner as in Example 1.

A content of Ti in the silica powder 3 used as the spherical silica precursor was measured to be 300 ppm.

### Example 4

Except that silica powder 4 (H-201, d50=20 μm, produced by AGC Si-Tech Co., Ltd.) produced by a wet method was used as the spherical silica precursor, the spherical silica powder was obtained in the same manner as in Example 1.

A content of Ti in the silica powder 4 used as the spherical silica precursor was measured to be 300 ppm.

### Example 5

An SUS vat was filled with 15 g of the silica powder 1 (H-31, d50=3.5 μm, content of Ti=300 ppm, produced by AGC Si-Tech Co., Ltd.) produced by the wet method similar to that used in Example 1, and followed by exposing in a constant temperature and humidity chamber at a temperature of 40° C. and a relative humidity (RH) of 80% for 24 hours to thereby obtain the spherical silica precursor.

An alumina crucible was filled with the entire amount of the obtained spherical silica precursor, followed by heat-treating in an electric furnace with a temperature of 1300° C. for 1 hour. After the heat treatment, the mixture was cooled to the room temperature, and was pulverized in an agate mortar to thereby obtain the spherical silica powder.

### Example 6

A 200 ml beaker is filled with 15 g of the silica powder 1 (H-31, d50=3.5 μm, content of Ti=300 ppm, produced by AGC Si-Tech Co., Ltd.) produced by the wet method similar to that used in Example 1, followed by adding 100 ml of ethanol and stirring for 1 hour, and then solid-liquid separation was performed, and the obtained solid was vacuum-dried at 60° C. for 24 hours to thereby obtain the spherical silica precursor.

An alumina crucible was filled with the entire amount of the obtained spherical silica precursor, followed by heat-treating in an electric furnace with a temperature of 1300° C. for 1 hour. After the heat treatment, the mixture was cooled to the room temperature, and was pulverized in an agate mortar to thereby obtain the spherical silica powder.

### Example 7

The 200 ml beaker is filled with 15 g of the silica powder 1 (H-31, d50=3.5 μm, content of Ti=300 ppm, produced by AGC Si-Tech Co., Ltd.) produced by the wet method similar to that used in Example 1, followed by adding 100 ml of distilled water, heating to 80° C. over 1 hour in a water bath, and stirring for 4 hours while maintaining the water temperature in the beaker at 78° C. to 82° C., and then the solid-liquid separation was performed, and the obtained solid was vacuum-dried at 100° ° C. for 24 hours to thereby obtain the spherical silica precursor.

An alumina crucible was filled with the entire amount of the obtained spherical silica precursor, followed by heat-treating in an electric furnace with a temperature of 1300° C. for 1 hour. After the heat treatment, the mixture was cooled to the room temperature, and was pulverized in an agate mortar to thereby obtain the spherical silica powder.

### Example 8

Except that silica powder 5 (H-33, d50=3.0 μm, produced by AGC Si-Tech Co., Ltd.) produced by a wet method was used as the spherical silica precursor, the spherical silica powder was obtained in the same manner as in Example 1.

A content of Ti in the silica powder 5 used as the spherical silica precursor was measured to be 300 ppm.

### Example 9

Except that silica powder 6 (H-51, d50=5.5 μm, produced by AGC Si-Tech Co., Ltd.) produced by a wet method was used as the spherical silica precursor, the spherical silica powder was obtained in the same manner as in Example 1.

A content of Ti in the silica powder 6 used as the spherical silica precursor was measured to be 1450 ppm.

### Example 10

Except that silica powder 7 (H-51, d50=5.5 μm, produced by AGC Si-Tech Co., Ltd.) produced by a wet method was used as the spherical silica precursor, the spherical silica powder was obtained in the same manner as in Example 1.

A content of Ti in the silica powder 7 used as the spherical silica precursor was measured to be 35 ppm.

### Example 11

10 g of the silica powder obtained in Example 1, 10 mg of 3-(methacryloyloxy)propyltrimethoxysilane, and 5 g of decane were mixed, and the solvent was distilled off by vacuum drying at 150° ° C. to thereby obtain surface-treated spherical silica powder.

### Example 12

Silica powder 1 (H-31, d50=3.5 μm, produced by AGC Si-Tech Co., Ltd.) produced by a wet method was used as the spherical silica precursor. A content of titanium (Ti) in the silica powder 1 was measured to be 300 ppm. An alumina crucible was filled with 15 g of the silica powder 1, followed by heat-treating in an electric furnace with a temperature of 1050° ° C. for 6 hours. After the heat treatment, the mixture was cooled to the room temperature, and was pulverized in an agate mortar to thereby obtain the spherical silica powder.

### Example 13

Spherical silica powder 8 (produced by Denka Company Limited: FB-5D) produced from silica as a raw material which is produced by a dry method was used. A content of Ti in the spherical silica powder 8 was measured to be 22 ppm. An alumina crucible was filled with 15 g of the spherical silica powder 8, followed by heat-treating in an electric furnace with a temperature of 1300° C. for 1 hour. After the heat treatment, the mixture was cooled to the room temperature, and was pulverized in an agate mortar to thereby obtain the spherical silica powder.

### Example 14

Spherical silica powder 9 (produced by ADMATECHS COMPANY LIMITED: SC-04) produced from the silica as the raw material which is produced by a VMC method was used as it was. A content of Ti in the spherical silica powder 9 was measured to be 28 ppm.

The spherical silica powder of Examples 1 to 14 was evaluated as follows. Results are shown in Table 1.

The FIGURE shows a scanning electron microscopic mirror observation image (SEM image) of the spherical silica powder of Example 1.

### “Evaluation”

### 1. Median Diameter

The median diameter was measured by a laser diffraction particle size distribution analyzer (MT3300EXII manufactured by MicrotracBEL Corp.). The measurement was performed after the spherical silica powder was dispersed by irradiating ultrasonic waves three times each for 60 seconds in the device. The measurement was performed twice each for 60 seconds, and an average value was obtained.

### 2. Specific Surface Area

The spherical silica powder was dried under reduced pressure at 230° ° C. to completely remove water, thereby obtaining a sample. Regarding this sample, the specific surface area was obtained by a multi-point BET method using a nitrogen gas in “TriStar II”, which is an automatic specific surface area and pore distribution measuring device manufactured by Micromeritics Instrument Corporation.

### 3. Pore Volume

The silica powder used as a precursor was dried under reduced pressure at 230° C. to completely remove water, thereby obtaining a sample. Regarding this sample, a pore volume was obtained by the BJH method using the nitrogen gas in “TriStar II”, which is an automatic specific surface area and pore distribution measuring device manufactured by Micromeritics Instrument Corporation.

### 4. Ignition Loss

In accordance with JIS K0067:1992, the mass loss when 1 g of the silica powder used as the precursor was heated and dried at 850° C. for 0.5 hours was defined as the ignition loss.

### 5. Concentration of Ti

The concentration was measured by inductively coupled plasma (ICP) emission spectrometry after adding perchloric acid and hydrofluoric acid into the silica powder used as the precursor, igniting the mixture, and removing silicon which was the main component.

### 6. Dielectric Loss Tangent

The dielectric loss tangent was measured by a perturbation resonator method using a dedicated device (vector network analyzer E5063A, manufactured by KEYCOM Corp.) at a test frequency of 1 GHZ, a test temperature of about 24° C., a humidity of about 45%, and three times of measurement. Specifically, after the spherical silica powder was dried under vacuum at 150° C., a cylinder made of polytetrafluoroethylene (PTFE) was filled with powder while sufficiently tapping, the dielectric constant was measured for each container, and then the dielectric constant was converted to the dielectric loss tangent using a filling rate of the powder in the container.

### 7. Amount of Silanol Group

An amount of the silanol group on the surface of the particles was measured by an infrared spectroscopy spectrum.

The infrared spectroscopy spectrum was measured by a diffuse reflection method using IR Prestige-21 (manufactured by Shimadzu Corporation) with spherical silica powder dispersed in diamond. A measurement range was 400 cm⁻¹ to 4000 cm⁻¹, a resolution was 4 cm⁻¹, and a cumulative number was 128.

The dilution to the diamond powder was defined as [mass dilution ratio]=[(sample mass])/([diamond mass]+[sample mass]), and [mass dilution ratio]=85−2.5×[BET specific surface area].

The spherical silica powder was vacuum-dried at 180° C. for 1 hour.

An IR spectrum was normalized at 800 cm⁻¹, a base line was aligned at 3800 cm⁻¹, and then a relative value of a Si—OH peak intensity in the vicinity of 3746 cm⁻¹ was obtained and a relative value of the bonded Si—OH peak intensity was obtained from the maximum peak at 3300 cm⁻¹ to 3700 cm⁻¹.

### 8. Viscosity and Particle Gauge

To examine the resin dispersibility of the spherical silica powder, the following test was performed.

6 parts of boiled linseed oil (produced by Yamakei Sangyo Co., Ltd.) and 8 parts of the spherical silica powder were mixed, and the mixture was kneaded with Awatori Rentaro (manufactured by Thinky Corporation) as a planetary mixer at 2000 rpm for 3 minutes to prepare a kneaded product. The obtained kneaded product was measured for 30 seconds at a shear speed of 1 s⁻¹ using a rotary rheometer, and the viscosity of the kneaded product was obtained at 30 seconds. The viscosity measured only with the boiled linseed oil was 46 mPa·s.

The obtained kneaded product was measured by a particle gauge method in accordance with JIS K5400: 1990.

### 9. Moisture Absorption Amount

To examine hygroscopicity of the spherical silica powder, the following test was performed.

After drying the spherical silica particles at 200° C., 5 g of the spherical silica particles were weighed in an aluminum dish with a diameter of 10 cm, and spread flat. The product left in an environment of 40° C. and 90% RH for 24 hours was measured by a Karl Fischer method (coulometric titration method).

### [Conditions of Karl Fischer Method (Coulometric Titration Method)]

Trace water measuring device (CA-200, manufactured by Mitsubishi Chemical Analytech Co., Ltd.
Water vaporizer (VA-200, manufactured by Mitsubishi Chemical Analytech Co., Ltd.)
Anolyte (Hydranal Coulomat AG-OVEN, produced by Hayashi Pure Chemical Ind., Ltd.)
Catholyte (Hydranal Coulomat CG, produced by Hayashi Pure Chemical Ind., Ltd.)
Heating temperature: 200° ° C.
Flow rate of nitrogen: about 250 ml/min

TABLE 1

| | | | Product of | | | |
|---|---|---|---|---|---|---|
| | | | specific surface | | | |
| | Specific | Median | area and median | Pore volume | Ignition loss | |
| | surface area | diameter | diameter | of precursor | of precursor | Ti |
| | m²/g | μm | μm · m²/g | ml/g | % by mass | ppm |
| Example 1 | 1.3 | 3 | 3.9 | 0.8 | 8.3 | 300 |
| Example 2 | 0.6 | 5 | 3.0 | 0.75 | 9 | 300 |
| Example 3 | 0.4 | 8 | 3.2 | 0.9 | 8.8 | 300 |
| Example 4 | 0.2 | 18 | 3.6 | 0.11 | 8.4 | 300 |
| Example 5 | 1.3 | 3 | 3.9 | 0.11 | 12 | 300 |
| Example 6 | 1.5 | 3.2 | 4.8 | 0.6 | 6 | 300 |
| Example 7 | 1.5 | 3.3 | 5.0 | 0.36 | 7.6 | 300 |
| Example 8 | 1.3 | 3 | 3.9 | 1.9 | 11.2 | 300 |
| Example 9 | 0.8 | 5 | 4.0 | 0.8 | 8.5 | 1450 |
| Example 10 | 0.9 | 4 | 3.6 | 0.8 | 8.1 | 35 |
| Example 11 | 1.3 | 3 | 3.9 | 0.8 | 8.3 | 300 |
| Example 12 | 1.6 | 3 | 4.8 | 0.8 | 8.3 | 300 |
| Example 13 | 2 | 4.7 | 9.4 | 0 | 0.1 | 22 |
| Example 14 | 4.5 | 1.5 | 6.8 | 0 | 0.1 | 28 |

| | Silanol | | | | | |
|---|---|---|---|---|---|---|
| | | Relative | | | | |
| | | intensity of | | | | |
| | | maximum | | | | Moisture |
| | Relative | peak at 3300 | Dielectric loss | Viscosity | Particle | absorption |
| | intensity of peak | cm⁻¹ to 3700 | tangent at 1 GHz | at 1 s⁻¹ | gauge | amount |
| | at 3746 cm⁻¹ | cm⁻¹ | — | mPa · s | μm | % |
| Example 1 | 0.03 | 0.14 | 0.0007 | 3150 | 25 | 0.006 |
| Example 2 | 0.03 | 0.14 | 0.0007 | 2200 | 30 | 0.004 |
| Example 3 | 0.03 | 0.14 | 0.0007 | 320 | 40 | 0.002 |
| Example 4 | 0.025 | 0.11 | 0.0006 | 250 | 50 | 0.001 |
| Example 5 | 0.03 | 0.14 | 0.0007 | 3150 | 25 | 0.006 |
| Example 6 | 0.045 | 0.18 | 0.0009 | 3500 | 25 | 0.007 |
| Example 7 | 0.048 | 0.19 | 0.001 | 3450 | 25 | 0.007 |
| Example 8 | 0.03 | 0.14 | 0.0007 | 3120 | 25 | 0.006 |
| Example 9 | 0.07 | 0.2 | 0.001 | 2250 | 30 | 0.005 |
| Example 10 | 0.02 | 0.1 | 0.0008 | 2230 | 30 | 0.005 |
| Example 11 | 0.01 | 0.12 | 0.0005 | 2800 | 25 | 0.002 |
| Example 12 | 0.04 | 0.21 | 0.0012 | 3150 | 25 | 0.015 |
| Example 13 | 0.15 | 0.35 | 0.003 | 18000 | 80 | 0.03 |
| Example 14 | 0.2 | 0.4 | 0.0022 | 11000 | 60 | 60 |

From the results of Table 1, it was found that, as a result of changing the product of the specific surface area and the median diameter of the spherical silica powder, the dielectric loss tangent, the viscosity, the particle gauge, and the moisture absorption amount of the spherical silica powders of Examples 1 to 12 were low, and when the product of the specific surface area and the median diameter was too large, the dielectric loss tangent deteriorated as results of Examples 13 and 14. The mater that the specific surface area is large with respect to the median diameter suggests the presence of fine particles, surface roughness, and the like, which is considered to increase an amount of surface residues and raise the dielectric loss tangent. It is considered that the presence of fine particles and surface roughness causes the resin composition to thicken and increase the viscosity. The median diameter is preferably 0.5 μm to 20 μm. This is because when the median diameter is small, the viscosity increases, and when the median diameter is large, the particle gauge increases.

From Examples 1 to 14, it was found that the dielectric loss tangent was low in the case where the ignition loss of the silica precursor was large. This is because in the case where the ignition loss of the silica precursor is less than 1.0%, the silanol group is likely to remain during firing, and thus the dielectric loss tangent increases. In the case where the ignition loss of the silica precursor exceeds 15.0%, it is predicted that the loss during firing increases and the yield deteriorates.

From Examples 1 to 14, it was found that the pore volume of the silica precursor also relates to the dielectric loss tangent. In the case where the pore volume is too small, the silica does not shrink when the silica precursor is fired, and the specific surface area is hardly reduced, and thus, it is assumed that the dielectric loss tangent increases.

### Test Example 2

A resin film was prepared using the spherical silica powders of Examples 1, 3, 11, and 14.

In 13 parts of methyl ethyl ketone (MEK), 25 parts of a biphenyl type epoxy resin (epoxy equivalent: 276, “NC-3000” produced by Nippon Kayaku Co., Ltd.) were dissolved by heating while stirring. After cooling to room temperature, 32 parts of an active ester curing agent (“HP8000-65T” produced by DIC Corporation, toluene solution containing having active group equivalent: 223, a non-volatile component of 65%) was mixed in the above mixture, and the obtained mixture was kneaded with the Awatori Rentaro (manufactured by Thinky Corporation) as a planetary mixer at 2000 rpm for 5 minutes. Subsequently, 0.3 parts of 4-dimethylaminopyridine (DMAP) and 1.8 parts of 2-ethyl-4-methylimidazole (“2E4M7.” produced by SHIKOKU CHEMICALS CORPORATION) were mixed as a curing accelerator, and the obtained mixture was kneaded with the Awatori Rentaro at 2000 rpm for 5 minutes. To the above mixture, 65.2 parts of the spherical silica powder was mixed, and the mixture was mixed at 2000 rpm for 5 minutes with the Awatori Rentaro.

Next, a transparent polyethylene terephthalate (PET) film (“PET5011 550” produced by Lintec Corporation, thickness: 50 μm) which was subjected to a releasing treatment was prepared. The obtained varnish was applied to the release treated surface of the PET film so as to achieve a thickness after drying of 40 μm by using an applicator and was dried and cured in a gear oven at 190° ° C. for 90 minutes. Thereafter, the product was cut to prepare a cured product (evaluation sample) of a resin film having a length of 200 mm, a width of 200 mm, and a thickness of 40 μm.

### (1) Evaluation of Dielectric Loss Tangent

The dielectric loss tangent (measured frequency: 10 GHz) of the obtained evaluation sample was measured with a split post dielectric resonator (manufactured by Agilent Technologies Japan, Ltd.). The obtained evaluation sample was stored in a constant temperature and humidity chamber at 85° C. and 85% RH for 24 hours, and the dielectric loss tangent was similarly measured for the evaluation sample after moisture absorption.

### (2) Measurement of Average Coefficient of Linear Expansion

The evaluation sample was cut into a size of 3 mm×25 mm. The sample was heated at a load of 5N and a temperature increase rate of 2° C./min using a thermomechanical analyzer (“TMA-60” manufactured by Shimadzu Corporation). Then, the dimensional change of the sample from 30° ° C. to 150° ° C. was measured, and the dimensional change of the long side was divided by the temperature to obtain the average coefficient of linear expansion) (ppm/° ° C.

Results are shown in Table 2.

TABLE 2

| | Dielectric loss tangent in | | |
|---|---|---|---|
| | measurement at frequency of 10 GHz | | Average coefficient |
| | After | After moisture | of linear expansion |
| | preparation | absorption | ppm/° C. |
| Example 1 | 0.007 | 0.0085 | 25 |
| Example 3 | 0.0068 | 0.0081 | 28 |
| Example 11 | 0.0065 | 0.0075 | 25 |
| Example 14 | 0.0075 | 0.0110 | 25 |

From the results shown in Table 2, the use of the spherical silica powders of Examples 1, 3, and 11 showed a low dielectric loss tangent of the spherical silica powder, and thus, the dielectric loss tangent of the resin composition was significantly improved. It was found that since the spherical silica powder of the present invention does not easily absorb moisture, the hygroscopicity of the resin composition is reduced, and excellent electrical characteristics are exhibited even after storage under humid conditions.

Although the present invention has been described in detail with reference to specific embodiments, it is apparent to those skilled in the art that various changes and modifications can be made without departing from the spirit and scope of the present invention. The present application is based on a Japanese Patent Application (No. 2021-123495) filed on Jul. 28, 2021 and a Japanese Patent Application (No. 2021-194372) filed on Nov. 30, 2021, the contents of which are incorporated herein by reference.

1. A spherical silica powder, having a median diameter d50 of 0.5 μm to 20 μm, and a product A×d50, which is a product of a specific surface area A (m²/g) and the median diameter d50 (μm), of 2.7 μm·m²/g to 5.0 μm·m²/g.

2. The spherical silica powder according to claim 1, having a dielectric loss tangent of 0.0020 or less at a frequency of 1 GHz.

3. The spherical silica powder according to claim 1, wherein
a kneaded product containing the spherical silica powder has a viscosity, which is measured by the following measuring method, of 5000 mPa·s or less,
(measuring method)
the kneaded product obtained by mixing 6 parts by mass of boiled linseed oil and 8 parts by mass of the spherical silica powder and by kneading the mixture at 2000 rpm for 3 minutes is measured for 30 seconds at a shear speed of 1 s⁻¹ using a rotary rheometer, and the viscosity of the kneaded product at 30 seconds is obtained.

4. The spherical silica powder according to claim 1, having a maximum IR peak intensity at 3300 cm⁻¹ to 3700 cm⁻¹, which is derived from a bonded silanol group on a surface of the spherical silica powder, of 0.2 or less.

5. The spherical silica powder according to claim 1, comprising 30 ppm to 1500 ppm of Ti.

6. A method for producing the spherical silica powder according to claim 1, the method comprising:
forming a spherical silica precursor by a wet method.

7. The method for producing the spherical silica powder according to claim 6, wherein
in accordance with JIS K0067:1992, when 1 g of the silica precursor is heated and dried at 850° ° C. for 0.5 hours, a mass loss of the silica precursor is 5.0% by mass to 15.0% by mass.

8. The method for producing the spherical silica powder according to claim 6, wherein
the silica precursor has a pore volume of 0.3 ml/g to 2.2 ml/g.

9. A resin composition, comprising:
5% by mass to 90% by mass of the spherical silica powder according to claim 1.

10. A slurry composition, comprising:
1% by mass to 50% by mass of the spherical silica powder according to claim 1.
